(19) United States
(12) Patent Application Publication
(10) Pub. No.: US 2012/0216828 A1
(43) Pub. Date: Aug. 30, 2012

(54) SUBSTRATE CLEANING DEVICE AND SUBSTRATE CLEANING METHOD

(75) Inventors: Junichi Tanaka, Osaka (JP); Akihiko Kohno, Osaka (JP)

(73) Assignee: SHARP KABUSHIKI KAISHA, Osaka (JP)

(21) Appl. No.: 13/504,242

(22) PCT Filed: May 17, 2010
(86) PCT No.: PCT/JP2010/003315

§ 371 Date: Apr. 26, 2012

(30) Foreign Application Priority Data
Oct. 27, 2009 (JP) 2009-246534

(51) Int. Cl. B08B 3/08; B08B 7/04; B08B 3/02

(52) U.S. Cl. 134/1; 134/115 R; 134/34; 134/32

(57) ABSTRACT

Disclosed is a substrate cleaning device provided with: a generation unit that generates ozone micro-nanobubble water; a nozzle header unit provided with a plurality of spray nozzles that spray the ozone micro-nanobubble water; and a substrate support unit that supports a substrate to be treated. The surface of the substrate supported by the substrate support unit is cleaned by spraying the ozone micro-nanobubble water from the plurality of spray nozzles onto the substrate.

### TECHNICAL FIELD

The present invention relates to a substrate cleaning device and to a substrate cleaning method.

### BACKGROUND ART

Photolithography is a mandatory step for manufacturing various elements such as TFTs (Thin Film Transistors) and colored layers of a color filter in a prescribed pattern on a substrate configuring a liquid crystal display panel, for example. For example, a resist is applied onto a semiconductor layer, and a resist pattern is formed by a normal photo process. Next, a semiconductor layer exposed from the resist pattern is removed by etching, and then the resist that is no longer necessary is removed to form a prescribed pattern. Circuits and wiring are formed on a substrate by repeating the cycle of applying a resist, forming a resist pattern, etching, and removing the resist as described above.

In a resist stripping step for removing a resist, a mixed solution of sulfuric acid and hydrogen peroxide, an amine organic solvent or the like are used, for example. These chemicals, however, damage a base film covered by the resist and also require a large amount of energy for disposing waste liquid, and therefore, they have significant problems in view of an environmental burden as well as a cost reduction.

For this reason, it has been discussed to use ozone water to perform the resist stripping step. Ozone water demonstrates superior effects in sterilization, deodorizing, bleaching and the like because of its strong oxidizing power. In addition to that, ozone gas is not likely to leave residues because it self-decomposes to harmless oxygen (gas) over time, hence it has been drawing attention as an environmental-friendly chemical.

However, stripping a resist using ozone water was not practical because the reaction rate of ozone water was slow. In light of this, as a method of using ozone water to strip a resist more efficiently, it is known a method of irradiating a resist with UV light at the same time as supplying ozone water to the resist to promote the decomposition rate of the resist.

In other words, for decomposing an organic substance such as a resist efficiently, it is effective to use oxidative radicals such as OH radicals having the oxidizing potential of no less than the binding energy of C—C (2.4V). Therefore, decomposition of a resist is promoted by irradiating ozone water with UV light to generate oxidative radicals.

Here, as shown in a cross-sectional view in FIG. 12, a cleaning device disclosed in Patent Document 1 is provided with a plurality of spray nozzles 102 for spraying ozone water, which are formed in a main body 101, and a UV light irradiation means 103 disposed between each of the spray nozzles. An ozone water generation device 104 that generates ozone water is connected to the main body 101. Ozone water supplied to the main body 101 from the ozone water generation device 104 is supplied to a substrate to be treated 105 from each of the spray nozzles 102, and at the same time, the substrate to be treated 105 is irradiated with UV light by the UV light irradiation means 103.

### RELATED ART DOCUMENTS

### Patent Documents

Patent Document 1: Japanese Patent Application Laid-Open Publication No. 2005-150165

### SUMMARY OF THE INVENTION

### Problems to be Solved by the Invention

Here, for sufficiently generating oxidative radicals by UV light irradiation, it is necessary to keep a distance between the substrate to be treated and the UV light irradiation means small, that is, approximately 5 mm or less, for example. On the other hand, for supplying ozone water evenly to the substrate to be treated, it is preferable that the ozone water spray nozzles be disposed relatively largely away from a surface of the substrate to be treated.

However, in the device disclosed in the above-mentioned Patent Document 1, the spray nozzles 102 and the UV light irradiation means 103 are disposed adjacent to the main body 101, hence it is difficult to dispose both the spray nozzles 102 and the UV light irradiation means 103 at preferable positions, respectively. As a result, there is a problem such that the arrangement (layout) of the spray nozzles 102 in the main body 101 becomes limited.

The present invention was devised in view of those aspects, and an object of the present invention is to clean a substrate to be treated efficiently by arranging the spray nozzles in a preferable position and by enabling a sufficient supply of oxidative radicals to the substrate to be treated.

### Means for Solving the Problems

To achieve the above-mentioned object, a substrate to be treated is cleaned by spraying ozone micro-nanobubble water thereon in this invention.

Specifically, the present invention is intended for a substrate cleaning device, including: a generation unit that generates ozone micro-nanobubble water that is a liquid containing ozone micro-nanobubbles; a nozzle header unit having a plurality of spray nozzles that spray the ozone micro-nanobubble water supplied from the generation unit; and a substrate support unit that supports a substrate to be treated such that the substrate faces the nozzle header unit. The present invention is configured such that the plurality of spray nozzles of the nozzle header unit spray the ozone micro-nanobubble water onto the substrate to be treated, which is supported by the substrate support unit, to clean the surface of the substrate to be treated.

The present invention is also intended for a substrate cleaning method. The plurality of spray nozzles provided in the nozzle header unit spray the ozone micro-nanobubble water, which is a liquid containing ozone micro-nanobubbles, onto a substrate to be treated to clean a surface of the substrate to be treated.

Processes

Next, processes of the present invention are described.

In a substrate cleaning device of the present invention, ozone micro-nanobubble water is first generated by the generation unit. The ozone micro-nanobubble water supplied from the generation unit is supplied to the nozzle header unit, and is sprayed from the plurality of spray nozzles of the nozzle header unit. Meanwhile, a substrate to be treated is supported by the substrate support unit such that the substrate faces the nozzle header unit. Ozone micro-nanobubble water sprayed from the above-mentioned plurality of spray nozzles is supplied to a surface of the substrate to be treated.

Here, oxidative radicals such as OH radicals are already contained in the ozone micro-nanobubble water, and therefore, it is possible to clean a surface of the substrate to be treated easily and efficiently by only spraying this ozone micro-nanobubble water onto the surface of the substrate to be treated.

Moreover, unlike the conventional device, a UV light irradiation means for irradiating the sprayed ozone water with UV light does not need to be formed in the nozzle header unit, and therefore, the structure of the substrate cleaning device becomes simple and the flexibility of an arrangement layout of the spray nozzles is increased. Accordingly, the spray nozzles can be arranged at a position more preferable for cleaning.

Furthermore, in a substrate cleaning method of the present invention, it is possible to clean a surface of the substrate to be treated easily and efficiently by only spraying ozone micro-nanobubble water onto the surface of the substrate to be treated in a manner similar to the substrate cleaning device of the present invention.

### Effects of the Invention

According to the present invention, oxidative radicals can be sufficiently supplied to a substrate to be treated by spraying ozone micro-nanobubble water onto the substrate to be treated for cleaning, and therefore, it is possible to clean a surface of the substrate to be treated easily and efficiently by only spraying ozone micro-nanobubble water onto the surface of the substrate to be treated. Moreover, it is also possible to increase the flexibility of an arrangement layout of the spray nozzles while simplifying the structure of the substrate cleaning device. Accordingly, the spray nozzles can be arranged at a position more preferable for cleaning.

### BRIEF DESCRIPTION OF THE DRAWINGS

FIG. 1 is an explanatory view showing a partial cross-section of a schematic configuration of a substrate cleaning device according to Embodiment 1.

FIG. 2 is an explanatory view showing a configuration of a generation unit according to Embodiment 1.

FIG. 3 is a plan view showing the schematic configuration of the substrate cleaning device according to Embodiment 1.

FIG. 4 is a cross-sectional view showing an enlarged view of a nozzle header unit according to Embodiment 1.

FIG. 5 is a flow chart showing a substrate cleaning method according to Embodiment 1.

FIG. 6 is an explanatory view showing the binding energy of molecules and the oxidizing potential of oxidative radicals.

FIG. 7 is a plan view showing a schematic configuration of a substrate cleaning device according to Embodiment 2.

FIG. 8 is a cross-sectional view showing an enlarged view of a nozzle header unit according to Embodiment 2.

FIG. 9 is a plan view showing a schematic configuration of a substrate cleaning device according to Embodiment 3.

FIG. 10 is a cross-sectional view showing an enlarged view of a nozzle header unit according to Embodiment 3.

FIG. 11 is an explanatory view showing a partial cross-section of a schematic configuration of a substrate cleaning device according to Embodiment 4.

FIG. 12 is an explanatory view showing a partial cross-section of a schematic configuration of a conventional substrate cleaning device.

### DETAILED DESCRIPTION OF EMBODIMENTS

Below, embodiments of the present invention are described in detail with reference to the figures. Note that the present invention is not limited to the following embodiments.

### Embodiment 1

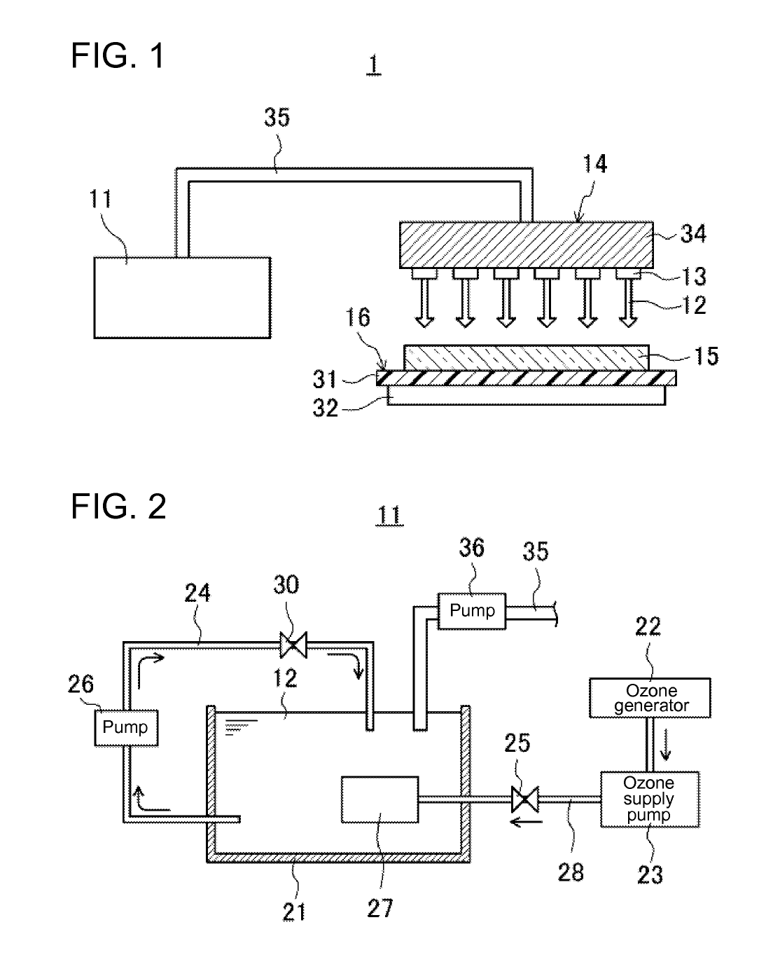

FIGS. 1 to 6 show Embodiment 1 of the present invention.

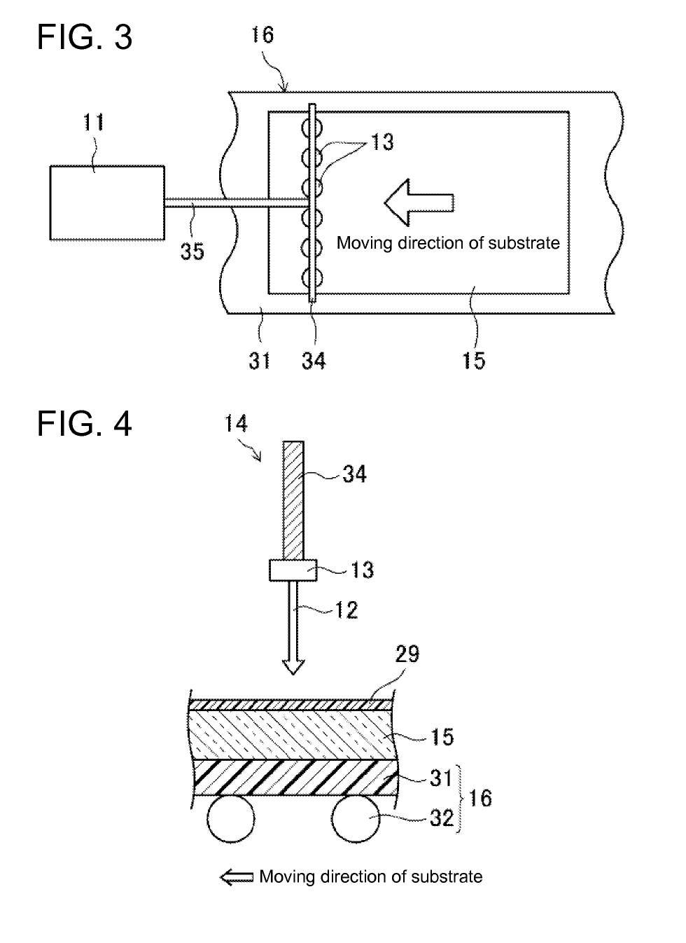

FIG. 1 is an explanatory view showing a partial cross-section of a schematic configuration of a substrate cleaning device 1 according to Embodiment 1. FIG. 2 is an explanatory view showing a configuration of a generation unit 11 according to Embodiment 1. FIG. 3 is a plan view showing the schematic configuration of the substrate cleaning device 1 according to Embodiment 1. FIG. 4 is a cross-sectional view showing an enlarged view of a nozzle header unit 14 according to Embodiment 1.

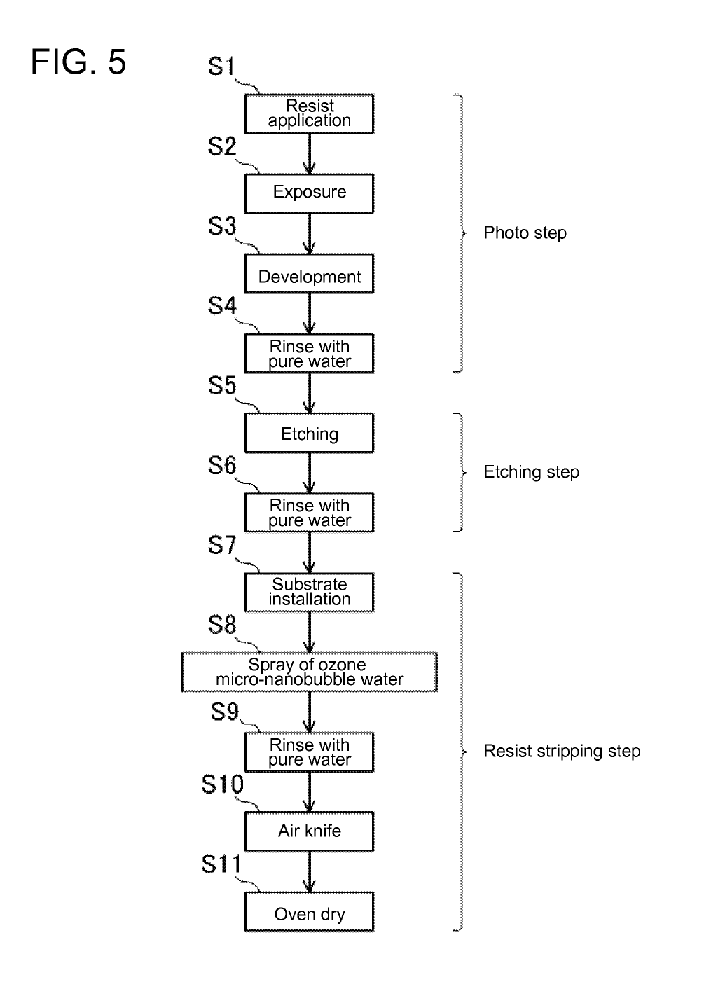

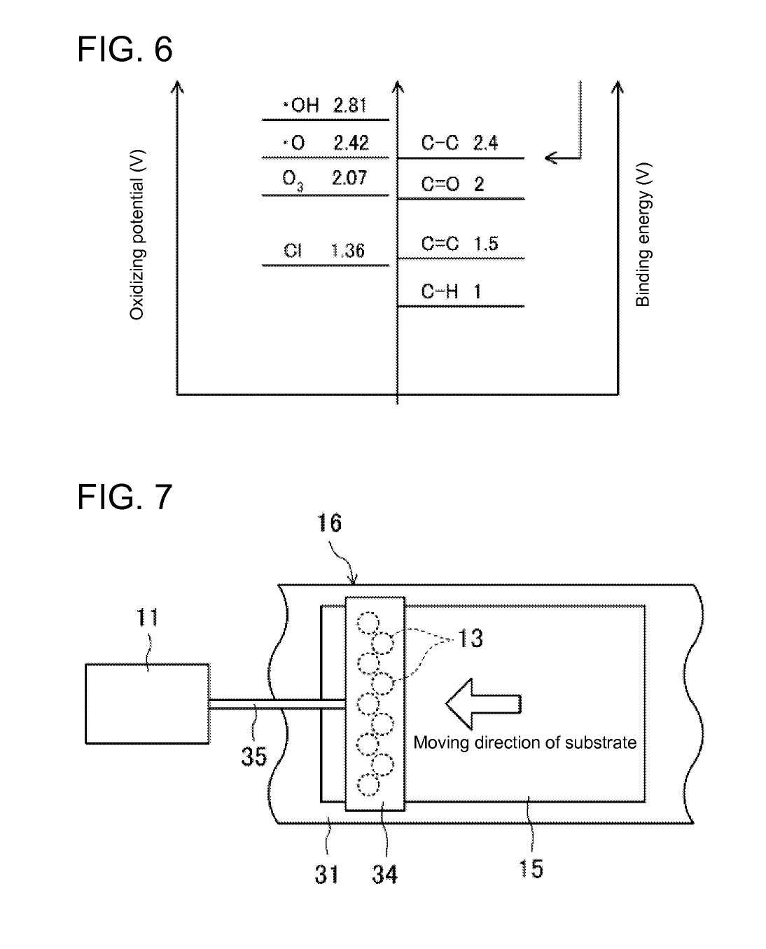

FIG. 5 is a flow chart showing a substrate cleaning method according to Embodiment 1. FIG. 6 is an explanatory view showing the binding energy of molecules and the oxidizing potential of oxidative radicals.

The substrate cleaning device 1 of Embodiment 1 is provided with the generation unit 11 that generates ozone micro-nanobubble water, the nozzle header unit 14 equipped with a plurality of spray nozzles 13, which spray ozone micro-nanobubble water 12 supplied from the generation unit 11, and a substrate support unit 16 that supports a substrate to be treated 15 such that the substrate faces the nozzle header unit 14.

Here, a micro-nanobubble means an air bubble with a diameter of 0.01 μm or more and 100 μm or less. An ozone micro-nanobubble means a micro-nanobubble in which gas inside the air bubble is ozone.

Ozone micro-nanobubble water means a liquid such as pure water that contains ozone micro-nanobubbles. The density of ozone micro-nanobubbles in ozone micro-nanobubble water is 1000 or more and 100000 or less per 1 ml.

The generation unit 11 includes, as shown in FIG. 2, a storage tank 21 that stores ozone micro-nanobubble water, an ozone generator 22, an ozone supply pump 23, a circulation pipe unit 24, and a pressure dissolution unit 27.

The ozone generator 22 is connected to the ozone supply pump 23. The ozone supply pump 23 is connected to the pressure dissolution unit 27, which is provided inside the storage tank 21, through a pipe 28 having an opening/closing valve 25. Moreover, one end of the circulation pipe unit 24 is connected to a bottom-side surface of the storage tank 21, and the other end is disposed at an upper opening of the storage tank 21. This circulation pipe unit 24 includes a pump 26, which makes ozone micro-nanobubble water at the bottom of the storage tank 21 pass through the circulation pipe unit 24 to supply the water to the upper opening side of the storage tank 21, and an opening/closing valve 30.

Accordingly, the generation unit 11 is configured to generate ozone micro-nanobibble water by the so-called pressure dissolution method.

In the pressure dissolution method, based on Henry's law, gas is dissolved in a liquid under a pressured environment, and then the pressure is reduced and released to generate air bubbles. In other words, ozone generated at the ozone generator 22 is supplied to the pressure dissolution unit 27 by the ozone supply pump 23 when the opening/closing valve 25 is open. In the pressure dissolution unit 27, ozone is pressured and dissolved in pure water in the storage tank 21 to generate ozone micro-nanobubbles. Ozone micro-nanobubble water in the storage tank 21 is circulated as needed by the circulation pipe unit 24 and the pump 26 when the opening/closing valve 30 is open.

The present embodiment uses the pressure dissolution method as a technique of generating micro-nanobubbles, however, an ultrahigh-speed rotation method, an air-liquid mixing shear method, a pore method, an ultrasound method or the like may also be used, for example. The present invention is not limited to these techniques.

The substrate to be treated 15 is a mother member of glass substrates configuring liquid crystal display panels, for example, and is formed in the size of 2200 mm×2400 mm, for example. As shown in FIG. 4, a patterned resist 29 is formed on a surface of the substrate to be treated 15 facing the nozzle header unit 14. The resist 29 undergoes exposure and development to become a mask resist for forming TFTs (Thin Film Transistors), wiring, or the like of a substrate configuring a liquid crystal display panel, for example.

The substrate support unit 16 is composed of a belt conveyer as shown in FIGS. 1 and 4. That is, the substrate support unit 16 includes a belt member 31 on which the substrate to be treated 15 is placed, and a plurality of rollers 32 that convey the belt member 31. The substrate support unit 16 is configured such that it moves the substrate to be treated 15 in a prescribed direction (to the left in FIGS. 3 and 4) while maintaining a constant distance between the substrate to be treated 15 and the nozzle header unit 14. The speed of conveying the substrate to be treated 15 is 1000 mm/min or more and 10000 mm/min or less.

The nozzle header unit 14 is fixed above the substrate support unit 16, and has a header main body 34 and the plurality of spray nozzles 13 formed below the header main body 34. Ozone micro-nanobubble water generated by the above-mentioned generation unit 11 is supplied to the header main body 34 through the pipe 35. The pipe 35 is provided with a pump 36 as shown in FIG. 2.

The plurality of spray nozzles 13 are arranged in a line as shown in FIGS. 1 and 3. The spray nozzles 13 are aligned in a direction perpendicular to the moving direction of the substrate to be treated 15 (that is, the width direction of the substrate to be treated 15). The spray nozzles 13 spray the ozone micro-nanobubble water 12 in a direction perpendicular to a surface of the substrate to be treated 15.

The inner diameter of a spray nozzle 13 is specified to be 0.05 mm or more and 0.5 mm or less. This way, it is possible to obtain the flow speed of ozone micro-nanobubble water that prevents the spray nozzles 13 from being clogged and that is suitable for cleaning the substrate to be treated 15. Also, an amount of ozone micro-nanobubble water sprayed from a spray nozzle 13 is 0.5 ml/cm²·sec or more and 100 ml/cm²·sec or less.

As described above, the substrate cleaning device 1 is configured such that it cleans a surface of the substrate to be treated 15 by spraying ozone micro-nanobubble water from the plurality of spray nozzles 13 of the nozzle header unit 14 onto the substrate to be treated 15, which is supported by the substrate support unit 16. The resist 29 formed on the substrate to be treated 15 is then stripped by the ozone micro-nanobubble water sprayed from each of the spray nozzles 13.

A Cleaning Method

Next, a resist stripping process, which is a method of cleaning the substrate to be treated 15 by the above-mentioned substrate cleaning device 1, is described along with a photo step and an etching step, which are the steps to be performed prior to the resist stripping step.

The present embodiment includes the following steps: a photo step in which the resist 29 is pattern-formed on a surface of a constituent material that is formed on the substrate to be treated 15, which is a large-sized glass substrate; an etching step in which the constituent material that is exposed from the resist 29 is etched; and a resist stripping step in which the resist 29, which is no longer necessary, is stripped and removed from the substrate to be treated 15.

In the photo step, steps S1 to S4 in FIG. 5 are performed. First, in step S1, a resist layer (not shown in the figure) is applied to and formed on a surface of a constituent material (such as a metal material and a semiconductor material, for example) formed in the substrate to be treated 15. Next, in step S2, the above-mentioned resist layer undergoes exposure. After that, in step S3, the exposed resist layer is developed. Next, in step S4, the substrate is showered and rinsed with pure water. The resist layer is patterned in this way so that the resist 29 is formed.

Then, steps S5 to S6 in FIG. 5 are performed in the etching step. First, in step S5, the constituent material that has been exposed from the patterned resist 29 is etched. Next, in step S6, the substrate is showered and rinsed with pure water. As a result, the constituent material is formed in a prescribed pattern.

In the resist stripping step, which is performed next, the substrate to be treated 15 is first placed on the substrate support unit 16 in step S7 in FIG. 5. Then, by the so-called single-wafer method, a plurality of the substrates to be treated 15 are conveyed and cleaned one by one.

In other words, in the following step S8, the plurality of spray nozzles 13, which are lined up in a direction perpendicular to the moving direction of the substrate to be treated 15, spray and supply ozone micro-nanobubble water onto the substrate to be treated 15 that has come to an area below the nozzle header unit 14. The surface of the substrate to be treated 15 is cleaned in this manner. Here, the ozone micro-nanobubble water is generated in the generation unit 11, and is supplied to the header main body 34 of the nozzle header unit 14 through the pipe 35. Here, the temperature of the ozone micro-nanobubble water is set to a room temperature or more and 60° C. or less.

Accordingly, the substrate to be treated 15 moves while being sprayed with ozone micro-nanobubble water, and therefore, the entire surface of the substrate is scanned with the ozone micro-nanobubble water. As a result, the resist 29 that has been formed and patterned on the surface of the substrate to be treated 15 is decomposed by oxidative radicals (such as OH radicals) of the ozone micro-nanobubble water. Thus, the resist 29 is stripped and the resist 29 on the substrate to be treated 15 is completely removed.

Next, in step S9, the substrate to be treated 15 is showered and rinsed with pure water. As a result, the ozone micro-nanobubble water remaining on the substrate to be treated 15 is replaced with clean pure water.

After that, in step S10, the surface of the substrate to be treated 15 is scanned by compressed air that is blown out from an air knife (not shown in the figure), and water drops remaining on the substrate to be treated 15 are blown away and removed. Next, in step S11, the substrate to be treated 15 is carried into an oven (not shown in the figure), and the surface of the substrate to be treated 15 is scanned by heated air, and then this substrate to be treated 15 is heated and dried at a high speed. Cleaning of a substrate is completed by performing the above-mentioned respective steps.

### Effects of Embodiment 1

Here, as shown in FIG. 6, for decomposing an organic material such as the resist 29 efficiently, it is effective to use oxidative radicals such as OH radicals having the oxidizing potential of no less than the binding energy of C—C (2.4V).

As shown in FIG. 6, the binding energy of C═O, C═C, and C—H are 2V, 1.5V, and 1V, respectively. Also, the oxidizing potential of OH radicals, O radicals, O₃ radicals, and Cl radicals are 2.81V, 2.42V, 2.07V, and 1.36V, respectively.

Here, in Embodiment 1, the substrate to be treated 15 is cleaned by being sprayed with the ozone micro-nanobubble water 12 containing oxidative radicals such as OH radicals, and therefore, the oxidative radicals can be supplied to the substrate to be treated 15 sufficiently. As a result, it is possible to decompose the resist 29 efficiently by only spraying the ozone micro-nanobubble water 12 onto a surface of the substrate to be treated 15, and therefore, the surface of the substrate to be treated 15 can be cleaned easily and efficiently.

Moreover, it is also possible to provide an increased flexibility in the arrangement layout of the spray nozzles 13 with a simplified structure of the substrate cleaning device 1. The spray nozzles 13 can be densely-arranged, for example, to be more suitable for cleaning.

### Embodiment 2

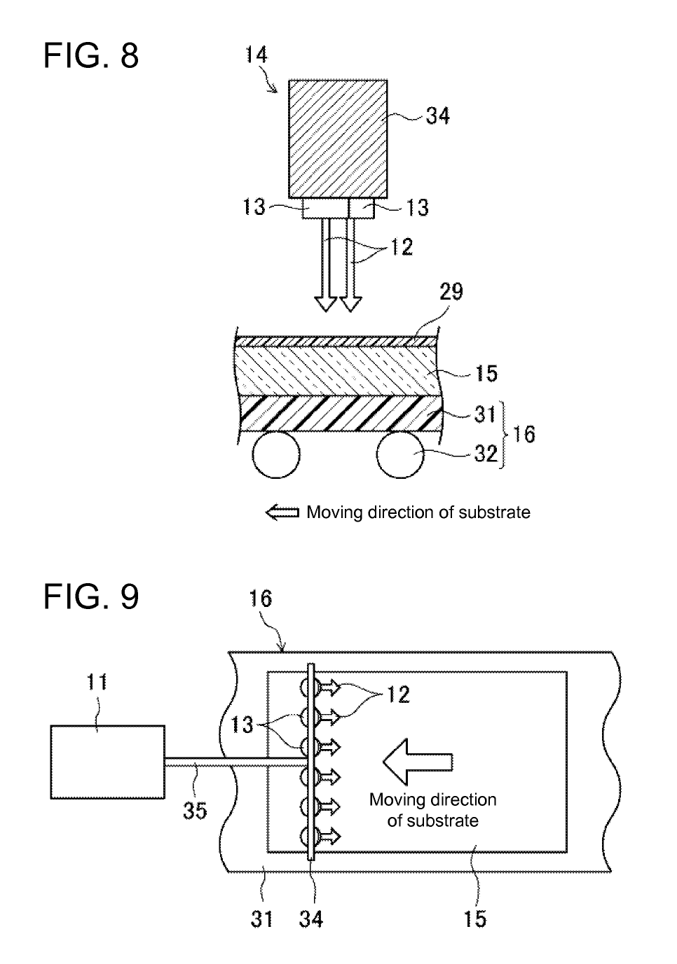

FIGS. 7 and 8 show Embodiment 2 of the present invention.

FIG. 7 is a plan view showing a schematic configuration of the substrate cleaning device 1 according to Embodiment 2. FIG. 8 is a cross-sectional view showing an enlarged view of the nozzle header unit 14 according to Embodiment 2. Here, in the following respective embodiments, the members same as those defined in FIGS. 1 to 6 are assigned the same reference characters, and the detailed description of them is omitted.

In the substrate cleaning device of Embodiment 2, the spray nozzles 13 in the nozzle header unit 14 are positioned differently.

In other words, as shown in FIGS. 7 and 8, the plurality of spray nozzles 13 are arranged at the nozzle header unit 14 in two lines and in a zigzag shape in a direction perpendicular to the moving direction of the substrate to be treated 15.

Therefore, according to this Embodiment 2, the plurality of spray nozzles 13 can be arranged densely in the moving direction of the substrate to be treated 15 as well as in a direction perpendicular to that direction, hence it is possible to increase a flow rate of the ozone micro-nanobubble water 12 per unit area of the substrate to be treated 15. Accordingly, the surface of the substrate to be treated 15 can be cleaned more easily and more efficiently.

### Embodiment 3

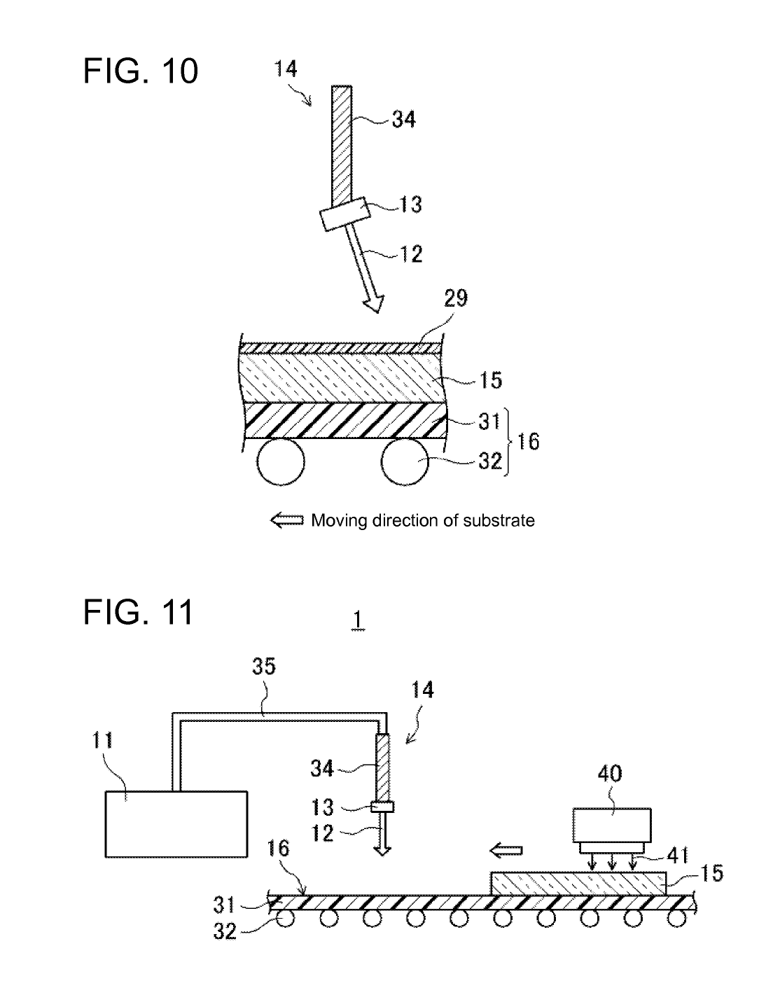

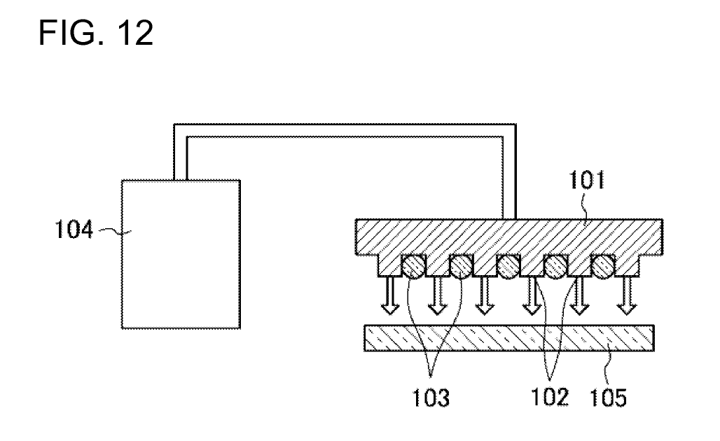

FIGS. 9 and 10 show Embodiment 3 of the present invention.

FIG. 9 is a plan view showing a schematic configuration of a substrate cleaning device 1 according to Embodiment 3. FIG. 10 is a cross-sectional view showing an enlarged view of the nozzle header unit 14 according to Embodiment 3.

The spray nozzles 13 of the above-mentioned Embodiment 1 were configured so as to spray the ozone micro-nanobubble water 12 in a direction perpendicular to a surface of the substrate to be treated 15, but the spray nozzles 13 of Embodiment 3 are configured so as to spray the ozone micro-nanobubble water 12 in a direction oblique to the surface of the substrate to be treated 15.

In other words, as shown in FIGS. 9 and 10, the spray nozzles 13 of Embodiment 3 are configured so as to spray the ozone micro-nanobubble water 12 onto a surface of the substrate to be treated 15 in an oblique direction inclined to a side (to the right) opposite to the moving direction of this substrate to be treated 15 (to the left in FIG. 9).

Here, described in Embodiment 3 was a configuration in which the spray nozzles 13, which spray the ozone micro-nanobubble water 12 in an oblique direction, are lined up in a single line in a direction perpendicular to the moving direction of the substrate to be treated 15, however, the configuration is not limited to such, and the spray nozzles 13 may be arranged in multiple lines, or arranged in a zigzag shape as in the above-mentioned Embodiment 2.

When the substrate to be treated 15 is cleaned using this substrate cleaning device 1, the substrate to be treated 15 is moved in a prescribed direction (to the left in FIG. 9, for example) while maintaining a constant distance between the substrate to be treated 15 and the nozzle header unit 14, and the ozone micro-nanobubble water 12 is sprayed from the plurality of spray nozzles 13 onto a surface of the substrate to be treated 15 in an oblique direction inclined to the side opposite to the moving direction of this substrate to be treated 15.

Consequently, according to Embodiment 3, stripped debris (referred to as a foreign substance) of the resist 29 on the substrate to be treated 15, which has been stripped by the ozone micro-nanobubble water 12 sprayed from the spray nozzles 13 in an oblique direction, is swept away toward the side opposite to the moving direction of the substrate to be treated 15. Then, this foreign substance is further swept away toward the side opposite to the moving direction of the substrate to be treated 15 by the ozone micro-nanobubble water 12 sprayed in an oblique direction. Thus, the foreign substance is kept swept away toward the side opposite to the moving direction of the substrate, and therefore, it is possible to prevent the foreign substance, which has been removed from the substrate to be treated 15, from sticking to the substrate to be treated 15 again.

### Embodiment 4

FIG. 11 shows Embodiment 4 of the present invention.

FIG. 11 is an explanatory view showing a partial cross-section of a schematic configuration of the substrate cleaning device 1 according to Embodiment 4.

Embodiment 3 is the substrate cleaning device of the above-mentioned Embodiment 1 that has a configuration in which the substrate to be treated 15 is irradiated with UV light in advance before spraying the ozone micro-nanobubble water 12 onto that substrate to be treated 15.

In other words, the substrate cleaning device 1 of Embodiment 3 is provided with a UV light irradiation unit 40 that irradiates the substrate to be treated 15 with UV light 41, as shown in FIG. 11. Meanwhile, the substrate to be treated 15 is placed on a belt conveyer that serves as the substrate support unit 16. Then, when the substrate to be treated 15 comes to a position facing the UV light irradiation unit 40, the substrate is irradiated with the UV light 41 by the UV light irradiation unit 40. After that, when the substrate to be treated 15 comes to a position facing the nozzle header unit 14, the nozzle header unit 14 sprays the ozone micro-nanobubble water 12 onto the substrate to be treated 15, which has been irradiated with the UV light 41.

Therefore, according to Embodiment 4, decomposition of the resist 29 on the substrate to be treated 15 is promoted by irradiating the substrate with the UV light 41. Accordingly, the substrate to be treated 15 provided with the resist 29 can be cleaned in a shorter amount of time.

### Other Embodiments

Description was made using an example of a glass substrate as the substrate to be treated 15 in the above-mentioned respective embodiments, however, the present invention is not limited to such, and the present invention is also applicable to other substrates in a similar manner. Further, a case of stripping a patterned resist on the substrate to be treated 15 was explained, however, the present invention is also applicable to a cleaning of the substrate to be treated 15 to which other foreign substances such as an organic substance are attached.

### INDUSTRIAL APPLICABILITY

As described above, the present invention is useful for substrate cleaning devices and substrate cleaning methods.

### DESCRIPTION OF REFERENCE CHARACTERS

1 substrate cleaning device
11 generation unit
12 ozone micro-nanobubble water
13 spray nozzle (nozzle header unit)
14 nozzle header unit
15 substrate to be treated
16 substrate support unit
29 resist
31 belt member (substrate support unit)
32 roller (substrate support unit)
34 header main body (nozzle header unit)
40 UV light irradiation unit
41 UV light

1. A substrate cleaning device, comprising:
a generation unit that generates ozone micro-nanobubble water that is a liquid containing ozone micro-nanobubbles;
a nozzle header unit having a plurality of spray nozzles that spray the ozone micro-nanobubble water supplied from said generation unit; and
a substrate support unit that supports a substrate to be treated such that the substrate faces said nozzle header unit,
wherein said plurality of spray nozzles of said nozzle header unit spray said ozone micro-nanobubble water onto a substrate to be treated, which is supported by said substrate support unit, to clean a surface of said substrate to be treated.

2. The substrate cleaning device according to claim 1,
wherein said plurality of spray nozzles are arranged in a zigzag shape in said nozzle header unit.

3. The substrate cleaning device according to claim 1,
wherein said substrate support unit moves said substrate to be treated in a prescribed direction while maintaining a constant distance between said substrate to be treated and said nozzle header unit.

4. The substrate cleaning device according to claim 3,
wherein said plurality of spray nozzles spray said ozone micro-nanobubble water onto a surface of said substrate to be treated in an oblique direction inclined to a side opposite to a moving direction of said substrate to be treated.

5. The substrate cleaning device according to claim 1, further comprising a UV light irradiation unit that irradiates said substrate to be treated with UV light,
wherein said nozzle header unit sprays said ozone micro-nanobubble water onto a substrate to be treated, which has been irradiated with UV light by said UV light irradiation unit.

6. The substrate cleaning device according to claim 1,
wherein a patterned resist is formed on a surface of said substrate to be treated facing said nozzle header unit,
wherein said resist is stripped by said ozone micro-nanobubble water sprayed from said plurality of spray nozzles.

7. A substrate cleaning method, comprising spraying ozone micro-nanobubble water via a plurality of spray nozzles provided in a nozzle header unit onto a substrate to be treated to clean a surface of said substrate to be treated, the ozone micro-nanobubble water being a liquid containing ozone micro-nanobubbles.

8. The substrate cleaning method according to claim 7, comprising
moving said substrate to be treated in a prescribed direction while maintaining a constant distance between said substrate to be treated and said nozzle header unit, and spraying said ozone micro-nanobubble water via said plurality of spray nozzles onto the surface of said substrate to be treated in an oblique direction inclined to a side opposite to a moving direction of said substrate to be treated.

9. The substrate cleaning method according to claim 7,
wherein said plurality of spray nozzles spray said ozone micro-nanobubble water onto a substrate to be treated that has been irradiated with UV light.

10. The substrate cleaning method according to claim 7,
wherein a resist that is formed and patterned on a surface of said substrate to be treated is stripped by said ozone micro-nanobubble water sprayed from said plurality of spray nozzles.
